(19) United States
(12) Patent Application Publication
(10) Pub. No.: US 2013/0073474 A1
(43) Pub. Date: Mar. 21, 2013

(54) SOCIAL NETWORK AND LOCATION-BASED EMPLOYMENT PLACEMENT SYSTEM AND METHOD

(71) Applicants: Sarah Young, Saint Paul, MN (US); John Hibscher, Saint Paul, MN (US); Steven Ladin, Plymouth, MN (US)

(72) Inventors: Sarah Young, Saint Paul, MN (US); John Hibscher, Saint Paul, MN (US); Steven Ladin, Plymouth, MN (US)

(21) Appl. No.: 13/621,776

(22) Filed: Sep. 17, 2012

Related U.S. Application Data
(60) Provisional application No. 61/535,673, filed on Sep. 16, 2011.

(51) Int. Cl. G06Q 10/06; G06Q 99/00

(52) U.S. Cl. 705/319; 705/321

(57) ABSTRACT

The present disclosure is directed to an online and mobile location-based system blending social, security and communication components to help persons, including youth, find employment and internship opportunities within a community. Utilizing users' social networks, geo-location, dynamic and real-time information feeds, and proprietary prediction and security technologies, the disclosed system provides a system to create validated personal profiles for job seekers and posters, to browse and search job listings, to communicate about with other users about employment opportunities. The present invention also assists job posters and organizations to communicate about available projects within their hyper-local area.

### CROSS-REFERENCE TO RELATED APPLICATIONS

This application claims the benefit of U.S. Provisional Application Ser. No. 61/535,673, titled SOCIAL NETWORK AND LOCATION-BASED EMPLOYMENT PLACEMENT SYSTEM, filed Sep. 16, 2011.

### BACKGROUND

Teenage unemployment rates in the United States are currently at an all-time high, upwards of 25-35%. Multiple research studies indicate that high levels of unemployment during the teenage years increase the difficulty of transitioning to part-time and full-time employment in the late teens and early twenties, as well as reduce future wage and earnings potential.

Today's teenagers need a safe and convenient way to find jobs in their communities. As web services targeted toward adult professionals have evolved over the years, it has become clear there is a tremendous untapped market for teenagers who need to make money and love to spend time online.

### SUMMARY OF THE INVENTION

The present disclosure is directed to an online and mobile location-based system blending social, security and communication components to help 13-17 year-olds find neighborhood jobs, part-time work and internship opportunities within their community. Utilizing users' social networks (for example, Facebook), real-world geographic location, dynamic and real-time information feeds, and proprietary prediction and security technologies, the disclosed system provides an intuitive and safe interface for teenagers to browse and search job listings, inquire about desired jobs, and announce their candidacy for employment. The present invention also assists job posters and organizations in promoting available projects within their hyper-local area.

Each teenager account is activated by either an adult sponsor (such as a parent or legal guardian) or an organizational sponsor who agrees to support the teenager. This feature utilizes role-based, tunable permissions, allowing the sponsor to oversee all the teenager's activity within the application, including jobs applied for and completed, communication with other users, etc. An additional opt-in layer of security is provided through background checks to verify identities and certify users.

As a user gains experience, their resume within the application grows, showing jobs completed, achievements earned, and recommendations from employers. Additional fields on each user's profile allow the user to share his or her earning goals, school activities, volunteer experiences, etc. The application also has game-like qualities, where users can earn stars to “level-up” by achieving different types of experience, completing specific activities, and referring their friends. Recommendation and referral features help the user learn the value of professionalism and the importance of building credibility and reputation. A significant feature of the present invention is security. The present invention creates a safe environment of reputation management, career-building, money management, resume-building and life experience that will contribute to each teenage user's future success.

### BRIEF DESCRIPTION OF THE DRAWINGS

FIG. 1 is a flow chart depicting a user experience according to one embodiment of the present invention.

FIG. 2 is an example graphical user interface wherein a user is prompted to log in using their credentials from an existing social media profile, according to one embodiment of the present invention.

FIG. 3 is an example graphical user interface illustrating an example registration page according to one embodiment of the present invention.

FIG. 4 is an example graphical user interface illustrating an example job search page according to one embodiment of the present invention.

FIG. 5 is an example graphical user interface illustrating an example job search page according to one embodiment of the present invention.

FIG. 6 is an example graphical user interface illustrating an example job search page according to one embodiment of the present invention.

FIG. 7 is an example graphical user interface illustrating a form that may be used to enter information about a new job posting according to one embodiment of the present invention.

FIG. 8 is an example graphical user interface illustrating an example message list according to one embodiment of the present invention.

FIG. 9 is an example graphical user interface illustrating an example resume tool according to one embodiment of the present invention.

FIG. 10 is an example graphical user interface illustrating an example resume tool according to one embodiment of the present invention.

FIG. 11 is an example graphical user interface illustrating an example resume tool according to one embodiment of the present invention.

FIG. 12 is a flow chart depicting the job poster approval process.

FIG. 13 is a flow chart depicting the process of job completion verification and teen safety tied to teen check-ins and location verification.

FIG. 14 is a schematic block diagram depicting an example computing system.

### DETAILED DESCRIPTION

In general terms, the present disclosure is directed to an online and mobile application that leverages users' existing networks (such as Facebook) and friends to help youth find opportunities, including use of a location- and social-network-based security system. In addition, the application can be used in connection with resources and organizations dedicated toward engaging and empowering teenagers to develop their skills Not only can teenagers use the application of the present invention within their existing social networks to find work in their area, they can utilize the resume-building features to market themselves to potential employers. Additional fields on each user's profile allow a user to share his or her earning goals, school activities, volunteer experience, and more. The application may be used by organizations that offer specific programs and resources for youth and teenagers that are pursuing entrepreneurship, developing leadership skills, and learning about money management, interview skills, goal-setting and resume-building.

The present invention creates an environment of career-building skills, money management skills, resume-building skills, and a foundation of life experience that will contribute to each teen user's path to future success.

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

The presently disclosed online or mobile application provides youth or other persons a straightforward, convenient way to find different types of jobs near their physical location. They will use the application to seek out things they enjoy doing to make money, promote their services to people in their community, and build a resume.

The application also offers a safe network and an opportunity for third parties, including parents, to be involved in maintaining both access to employment and personal safety.

In addition, the application provides job posters the ability to quickly find young, ambitious, local workers to fill odd jobs, or part-time or temporary positions, also from a location- and social network-validated group.

### Social-Graph Integration

The application described herein is a social network-integrated application that will leverage users' existing networks and friends to help teens and others find opportunities to connect with job posters and find local employment. Facebook is one example of a social network, but the system herein can also leverage, connect and integrate with other social networks.

### Location-Based Technology

The application allows teenagers to filter posts by what types of jobs they are interested in and search for jobs near home, or current location. Location-based technology allows teenagers to “check-in” to the physical job site via the disclosed mobile application on a mobile device. The teenagers have privacy options wherein they can choose to share their current activity with their networks. If the teenager checks in, a text or email message could be sent to their sponsor and/or provide GPS tracking of the teenager's real-world geographic location or dynamic basis on a web-generated map.

### Role-Based, Tunable Permissions

Sponsors have oversight of all of their sponsored teenager's activity within the application including, but not limited to, jobs applied for, jobs completed, and communication amongst other users.

### General

Sponsors configure access to the teenager's application settings. Optional settings can include, but are not limited to:
Job search radius (0-100 miles)
Job search types (yard work, babysitting, etc.)
Require poster background check (yes/no)
Allow roaming (can search jobs from current location, or just home location)
Require in-social-network connection to job poster (yes/no)

Sponsors may configure notification settings, including but not limited to:
Receive status updates via several channels for themselves, and also for each sponsored teenager separately. For example, receive email updates weekly for new job postings in area (sponsor), and at the same time receive text updates as they occur for teenager #1, age 13, and also receive email updates for teenager #2, age 17.
Independently configure notification types: new jobs in area, reply to message, etc.

Teenagers may configure notification settings:
Receive status updates via several channels for themselves (text messages, social networks such as Facebook, email)
Independently configure notification types: new jobs in area, reply to message, etc.

### Messages

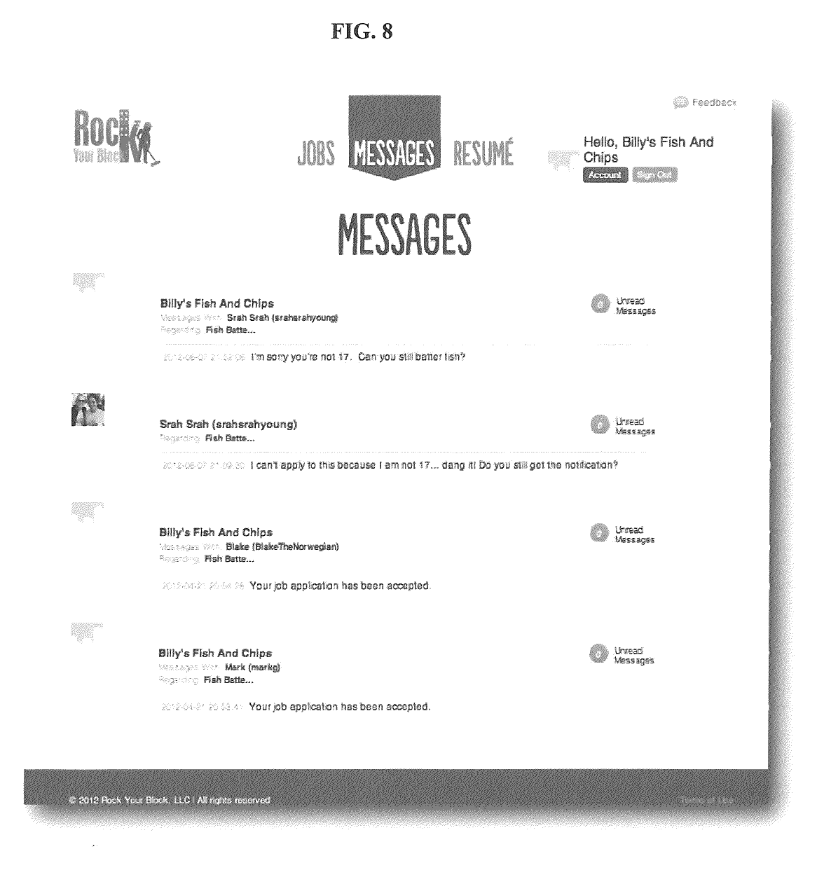

Any user who is a sponsor of a teen user will have the ability to select whether to view their own message list, or the message list of one of the teenager that they are sponsoring. An example message list is illustrated in FIG. 8.

### Jobs

Any user who is a sponsor of a teen user will have the ability to select whether to view jobs in just the vicinity of their own home location, the home locations of the teenager(s) they are sponsoring, or the current location of the teenager(s) that they are sponsoring, or a combination of these options. They can also choose to view “all” jobs for themselves including all jobs for their sponsored teenager(s).

### Resume-Builder Technology

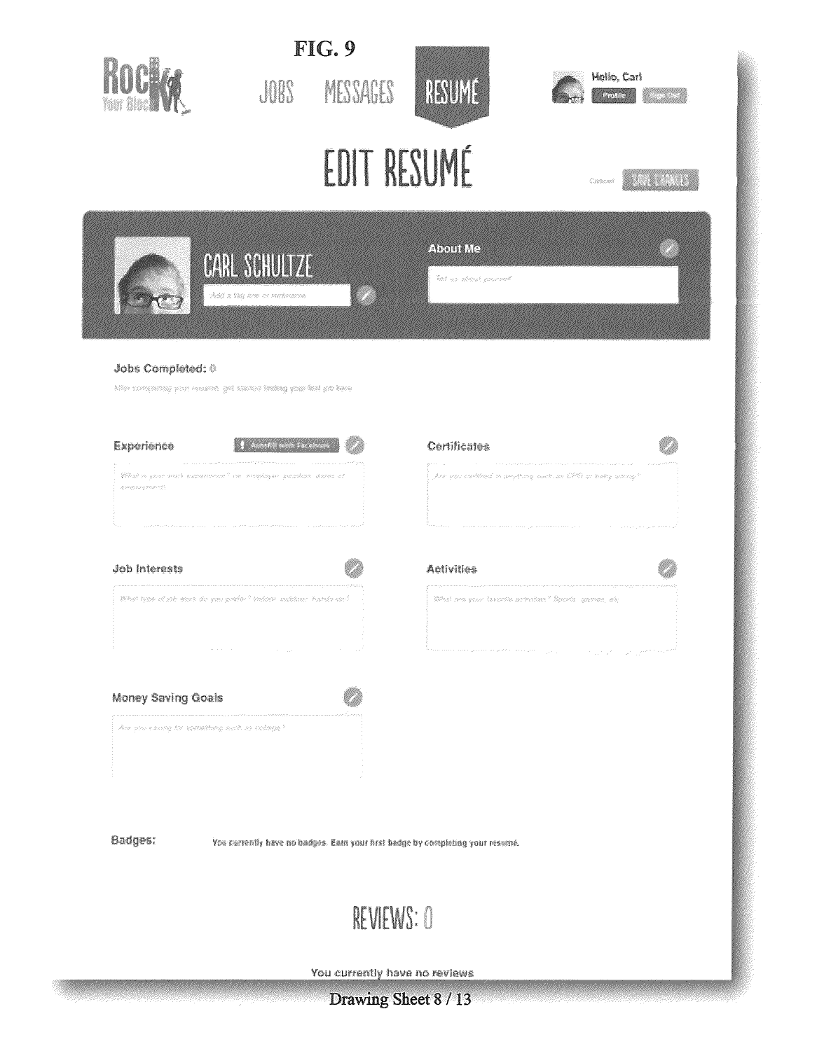

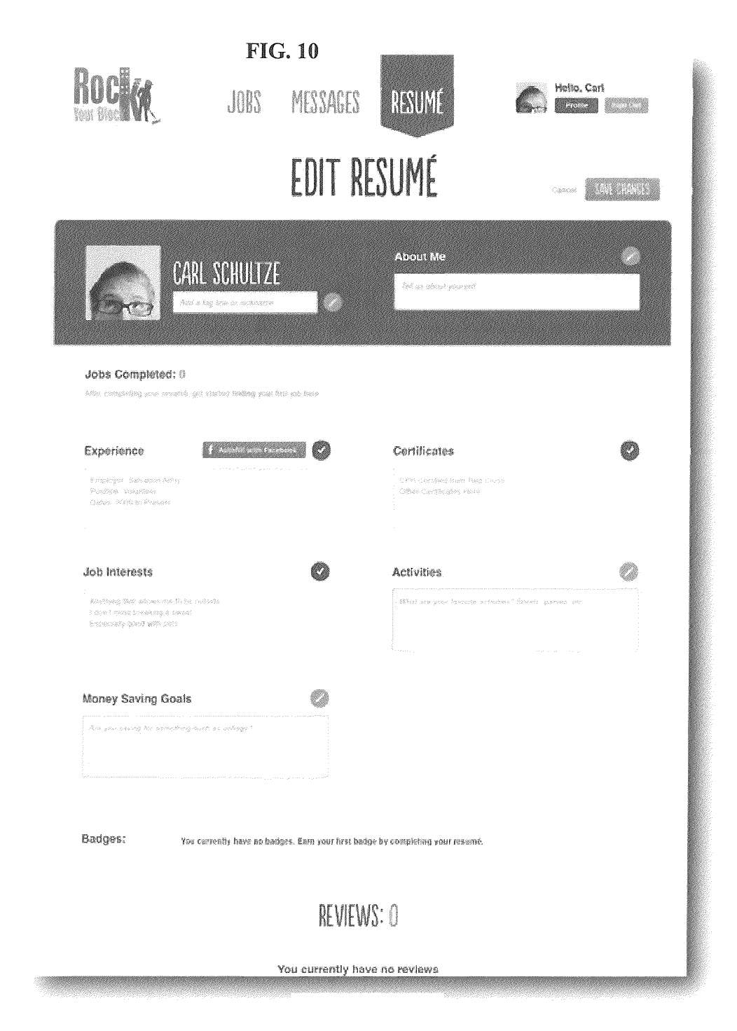

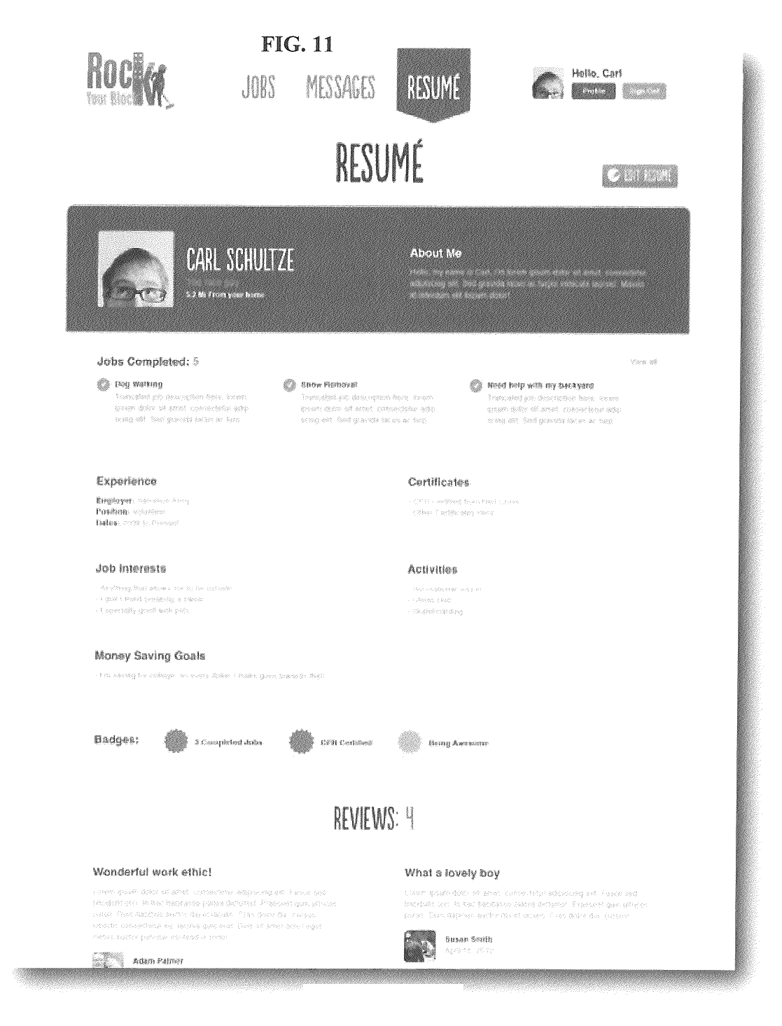

As teenagers complete jobs, the resume tool updates their work experience. An example of the resume tool is illustrated in FIGS. 9 through 11. Each entry reflects the details about the work performed and who the employer was. Employers are prompted to write a review or recommendation for the teenager once a job has been fulfilled. These reviews will appear on the teenager's resume.

Export and email features allow the teenager to download their resume from the disclosed application to use for outside activities including, but not limited to, applying for professional jobs, applying for college, applying for scholarships, and other endeavors.

### Game-Play Mechanics

Teenagers earn stars and can “level-up” in status by achieving different types of experience, completing specific activities, and/or referring their friends. Teenagers will want to earn a better status and build their recommendations and certifications (badges) to make them more attractive to potential employers.

### Additional Security Technology

The present invention places a strong emphasis on safety by using four layers of security, including:
1. Social-Graph Integration
2. Location-Based Verification Technology
3. Sponsor Roles-Based Tunable Permissions
4. Employer/Job Poster Background Checks.

The process used by the system for verifying identities mitigates the risk of users saying they are someone they are not. The process addresses risks such as false identity, knowledge of whereabouts and proximity to location of parent or other guardian or sponsor.

Resources and tips for safe use of the application and best practices for working for new people in the teenagers' neighborhoods may be provided within the online or mobile application. Sponsors can set restrictions on their teenager's ability to apply to jobs. For example, the sponsor may indicate that his or her teenager is only allowed to apply to jobs from people that have a direct relationship with the teenager on a social media network (1^{st} degree connections only). Alternatively, the teenager may only be permitted to apply for jobs from designated groups of friends, family or neighbors. Additional geographic limitations could be included, such as “no location more than ½ mile from the teenager's residence” or “no more than three blocks from a designated family or friend location.”

Other safety precautions in place may include optional criminal and watch-list background checks for unverifiable individual job posters and third-party moderation of transactions and communications related to safety and security risks.

### User Case Scenarios

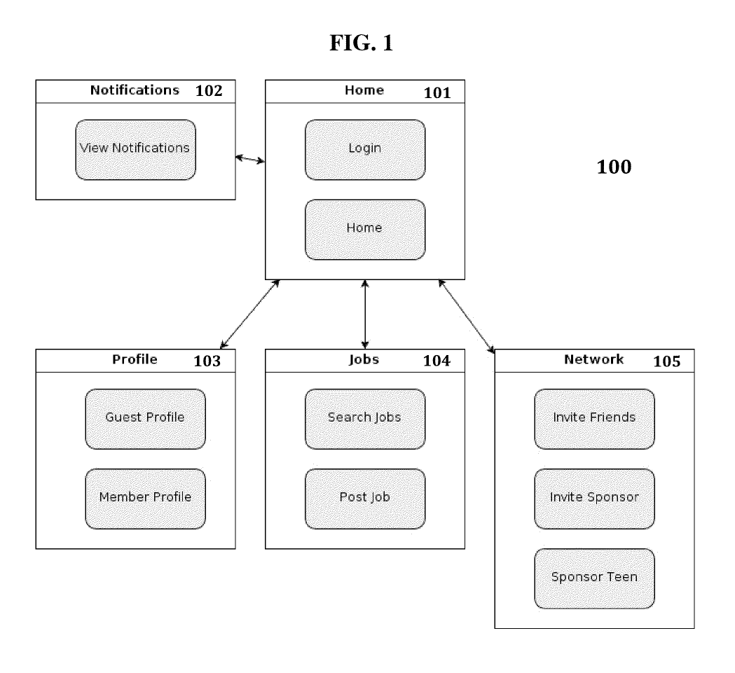

The flow chart of FIG. 1 depicts an example of a user experience 100 according to one embodiment of the present invention, as described in more detail in the user case scenarios below. Each user has a “Home” screen 101 within the application. The “Home” screen 101 includes a login requirement and a home screen interface. The application further includes a “Notifications” screen 102, where a user has the option to view notifications (among other things). Each user has a “Profile” 103 within the application. A user's “Profile” 103 may be a guest profile or a member profile. A user also has a “Jobs” screen 104 within the application, which may include the option to search for a job or post a job, depending on the type of user (for example, a teenager job seeker may have the option to search for jobs and a job poster may have the option to post a job). Each user further has a “Network” page 105 within the application which allows the user to invite friends to use the application, invite a sponsor, or sponsor a teen within the application.

### Teenager Job Seeker

In one example scenario, a teenager living in Minneapolis wants to make money by babysitting, dog walking, or performing other odd jobs in their neighborhood. The teenager may see a post in their newsfeed on a social media network that a friend found a job mowing lawns in NE Minneapolis, and may click on the wall post, which will take the teen to the presently disclosed application.

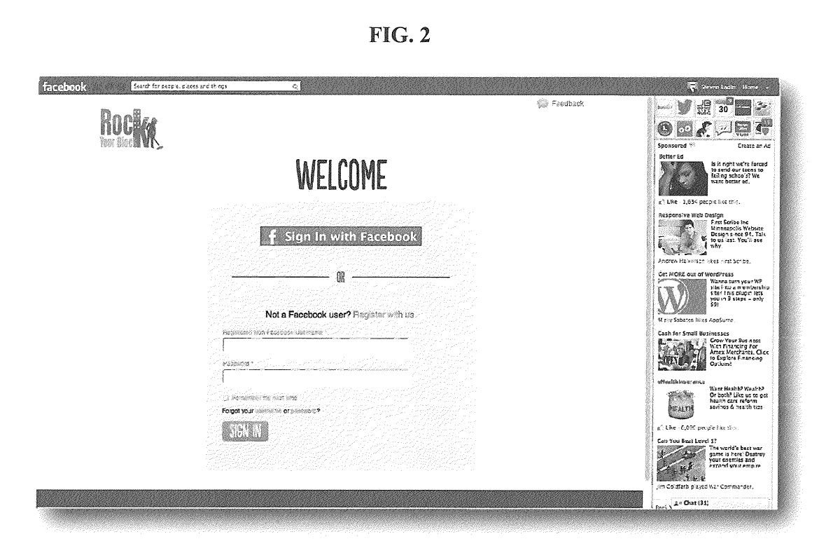

If the teenager decides to add the application to their applications on the social media network, the teenager may be required to allow requests for permissions to access some of their public information on the social media network (which is standard for many social media network applications). Upon future visits to the application, the user may be prompted to login using their credentials from the social media network, as depicted in FIG. 2.

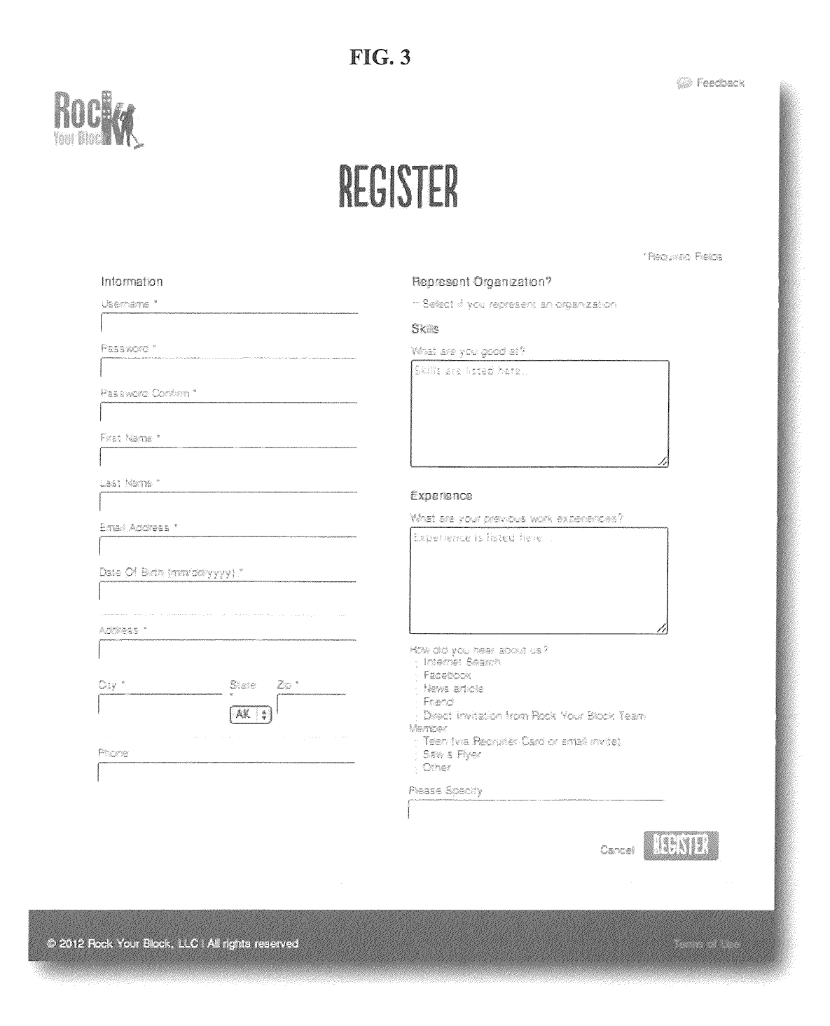

The teenager is required to complete their profile within the application, which is automatically populated with some information from their social media network profile including the teenager's photo, location, birthday, school and work experience. The teenager can optionally add money-saving goals, activities, certifications, and job interests. An example registration page is illustrated in FIG. 3.

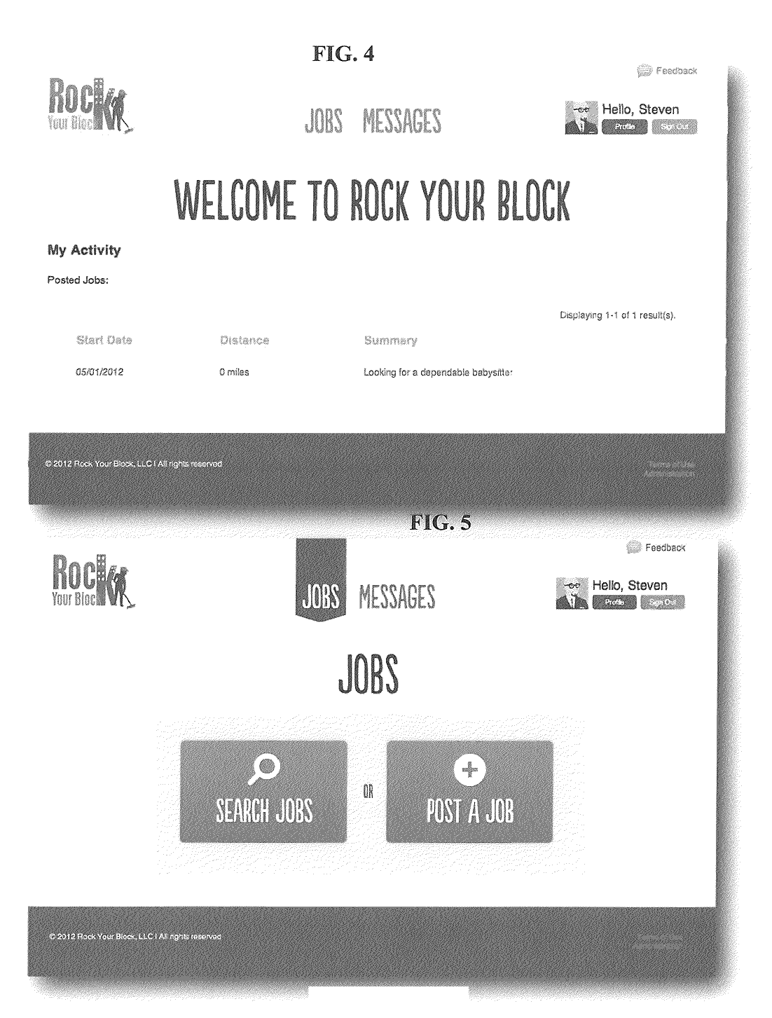

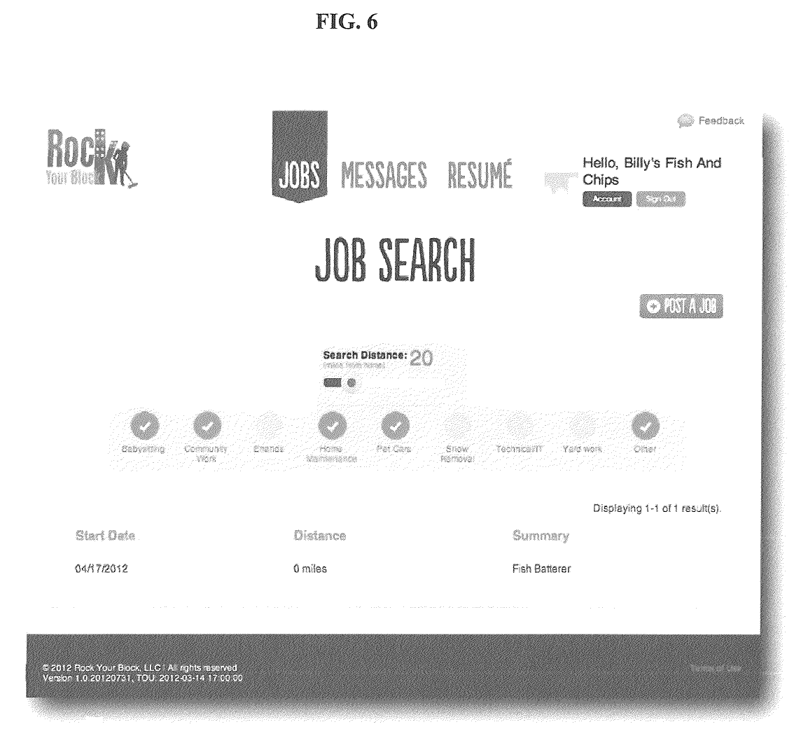

Once their profile is complete, the teenager is then taken to the job search page, examples of which are shown in FIGS. 4 through 6. The teenager can search for jobs by category, or simply within a distance range. In this example, the teenager finds a dog-walking job just one mile away. The teenager sees options to request more information about the job or apply for the job. In this case, the teenager decides to ask for more information. In order to request more information or apply for a job, the teenager must first have an adult sponsor.

In this case, the teenager has not yet obtained a sponsor, so the job they were viewing is bookmarked, and they are routed to the “Invite” area of the application where they can select a parent, guardian or responsible adult whom they feel would be willing to sponsor them. The page also explains how the teenager's sponsor will help the teenager make decisions in their communications with other users. The invite can be made by entering the email address of the prospective adult sponsor, or by choosing them from the teenager's friends on a social media network. The teenager also has the option to add a personalized message to the sponsorship request. Once the sponsor invitation is sent, the teenager can continue building their resume, browsing job listings, or inviting friends to join the application.

Once the sponsor fills out a profile and consents to sponsoring the teenager, the teenager receives a notification that they can now request information from job posters and apply for jobs. The teenager may return to the Jobs page, view bookmarked jobs and take action. The teenager decides to apply for the job, and clicks “Apply for this Job!” which will submit a notification—with or without a personal message included—to the job poster indicating the teenager's interest.

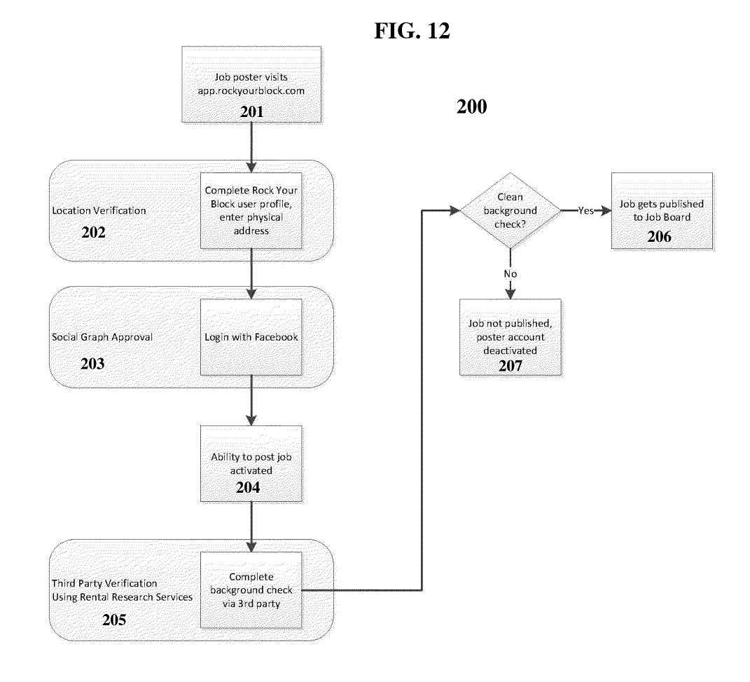

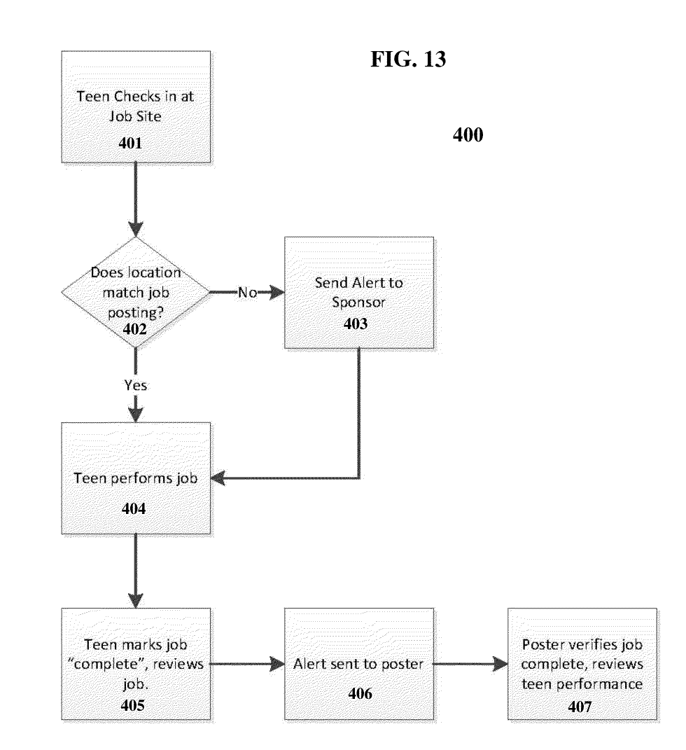

A flow chart depicting the process of job completion verification 400 and teen safety tied to teen check-ins and real-world geographic location verification is shown in FIG. 12. A teen first checks in at a job site 401 using the disclosed application, and the application uses location-based verification technology to determine whether the check-in location matches the location in the job posting (402). If the check-in location does not match the location in the job posting, an alert is sent to the teen's sponsor 403. This alert could be by text message (SMS or other), automated phone call or email. If the location does match, no alert is sent and the teen may perform the job 404. Once the job is complete, the teen may use the online or mobile application to mark the job as complete and may review the job 405. An alert is sent to the job poster 406, and the poster may then verify the job as complete and review the teen's performance 407. Such completion notice can also be provided to parent or other guardian.

### Sponsor (Parent or Legal Guardian)

After the teenager submits a sponsorship request, the teenager's parent or legal guardian receives an email from the teenager via the application requesting sponsorship for the teenager to start using the local job searching application. The email request may contain a personalized message from the teenager explaining why they want to start using the application. It will also include a link, which the parent or guardian can click on to learn more about the application.

Clicking on this link might bring the parent or guardian to a page within a social media network, which will prompt the parent or guardian to log in to their account on that network. After logging in, the parent or guardian is brought to a page within such social media network where they can read more information about the application and why the teenager is required to have a sponsor to allow the teen to use the service. The page may contain text explaining the role of the sponsor; the page may also contain text explaining safety and security features of the application.

If the parent or guardian chooses to sponsor the teenager, they may click on a link reading “Sponsor your teenager!” Clicking this link will bring the parent or guardian to a page that may require them to click a link to allow requests for permissions to access some of their public information on the social media network (which is standard for many social media network applications).

The parent or guardian is then brought to a payment processing page, which explains the yearly membership fee that activates the teenager's account. Once the account is active, the teenager can immediately start applying to jobs in their area. The parent or guardian will be asked to confirm and submit a payment. If they do so, they will become a sponsor; the sponsor is then brought to a verification/thank you page that thanks them for their sponsorship, and then asks, “What would you like to do next?” The options include: “Complete Your Profile,” “Browse local job opportunities,” “View your teenager's profile,” and “Invite Friends.”

If the sponsor clicks on “Complete Your Profile,” they are brought to a page within the application that shows their sponsor profile. This already includes the sponsor's profile picture from their profile on the social media network, city/network, sponsored teenager's name (linked to the teenager's profile within the application), and work experience. This information is populated using the sponsor's social media network profile information.

If the sponsor clicks on “View your teenager's profile,” they will be taken to their sponsored teenager's profile and will be able to view information such as the teenager's listed part-time jobs, volunteer experience, personal statement, and other skills or experience.

### Organizational Sponsor (Community Organization Sponsor)

An organization or other group entity may also serve as a sponsor for an individual teenager or a group of teenagers. A community organization can use the disclosed application to find job opportunities for teenagers involved with their organization, or in the community. The method for signing up as a community organization is the same as signing up as a job seeker (described above).

Once the community organization is signed up as a user, they can view job postings including postings where the job poster is seeking multiple teenagers to perform a large job for them. For example, a local church may be seeking 20 teenagers to paint their cafeteria on a very limited budget. If a youth club that has signed up as a community organization user thinks they have 20 (or other specified) teenagers within the youth club that would like to help with the project, the community organization user can send out invites to a number of teenagers that may be interested; the first 20 (or other specified number) teenagers to accept the invitation get the job. In this example, the teenagers would also get a reward, like a badge. For example, the teenagers might receive a “Teamwork Badge,” for participating in a job along with other teenagers; the youth club would get a badge, for example, “Awesome Org Badge,” for finding the teens to fulfill the job.

### Job Poster

In another example user scenario, an adult user may have odd jobs, part-time or temporary jobs, or another type of work that they would like performed by a local teenager. The user may go to the application's website, which takes the user to a landing page that shows information about what the application is and also includes a button to register as a user. Clicking this button may direct the user to a social media network, where they are prompted to log in to their account on that social media network. Once the user logs in, the application may require the user to allow requests for permissions to access some of their public information on the social media network (which is standard for many social media network applications).

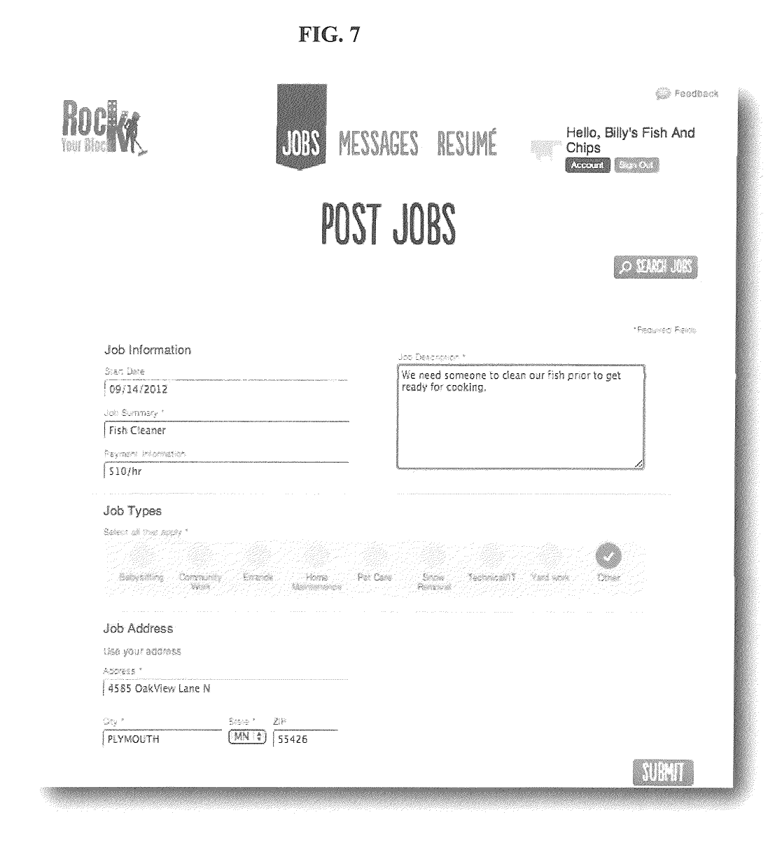

If the user chooses to proceed, they will be brought to a page that asks if they are a “Job Seeker,” “Job Poster,” or “Sponsor.” To post a job, the user would click on “Job Poster,” which brings them to a page with a simple form, such as the form depicted in FIG. 7, to provide information about what type of job the user is posting, when they need the job completed, what their address is (kept private until the teenager hire is found), and a description. There is a drop-down list of job types to choose from, such as pet care, lawn care, personal assistance, cleaning, car wash, etc.

After completing the job posting form, the user clicks on “Post Job” to complete the job posting, which will bring up a success page that includes options to post another job or complete the user's profile. The user can then log in to their account at later times to check for replies to the job posting.

A flow chart demonstrating the job poster verification process 200 is depicted in FIG. 12. A job poster first visits the web page of the application 201. The job poster then completes their user profile within the application, including entering a physical address to facilitate location verification 202. The job poster may log in using their account on a social media network, which allows for social-graph approval 203. The job poster's ability to post jobs is then activated (204). The application uses a third party to verify the job poster and complete a background check on the job poster (205). If the background check is clean, the job gets published 206; if the background check is not clean, the job is not published and the job poster's account is deactivated (207).

Upon completion of a job, the poster can make payment through the system to the teenager or their sponsor via standard e-commerce functionality or other credit card or bank-based payment system (such as PayPal, Square or other means). Payment approval can be tied to validated completion of a specified job, including through the capture of image data displaying an area in which work has been completed. The poster will also be able to rate performance of the teenager on the job. The teenager and/or the sponsor will also be able to rate the work experience provided by the poster.

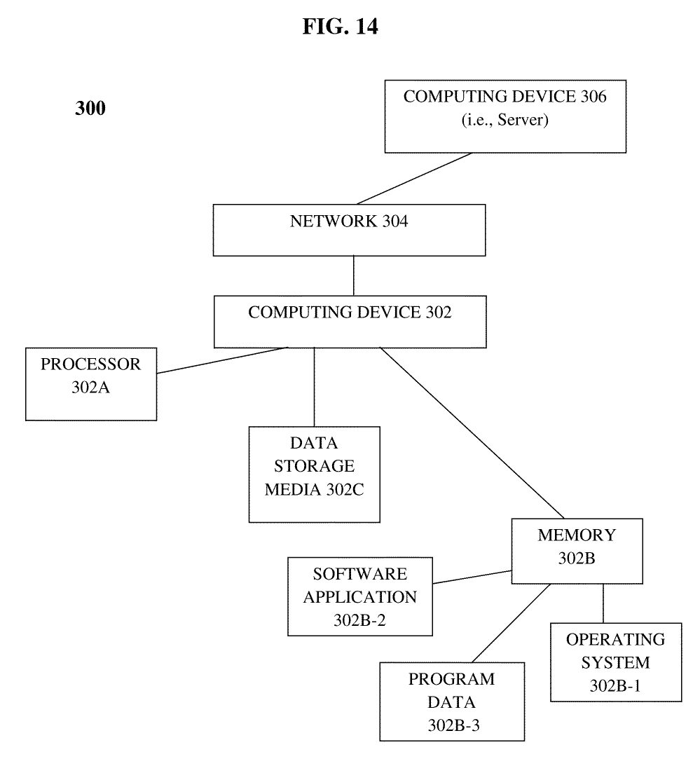

In general terms, the present disclosure relates to an online or mobile application that is executed using a computing system 300. FIG. 14 is a schematic block diagram of an example computing system 300. The example computing system 300 includes at least one computing device 302. In some embodiments the computing system 300 further includes a communication network 304 (such as the internet or a cellular network) and one or more additional computing devices 306 (such as a server).

Computing device 302 can be, for example, a smart phone or other mobile device, a tablet computing device, a netbook, a computing device located in a user's home or any other computing device. Computing device 302 can be a stand-alone computing device 302 or a networked computing device that communicates with one or more other computing devices 306 across network 304. Computing device 306 can be, for example, located remote from computing device 302, but configured for data communication with computing device 302 across network 304. Computing device 306 can be, for example, a server.

In some examples, the computing devices 302 and 306 include at least one processor or processing unit 302A and system memory 302B. Depending on the exact configuration and type of computing device, the system memory 302B may be volatile (such as RAM), non-volatile (such as ROM, flash memory, etc.) or some combination of the two. System memory 302B typically includes an operating system 302B-1 suitable for controlling the operation of the computing device, such as the WINDOWS® operating systems from Microsoft Corporation of Redmond, Wash. or a server, such as Windows SharePoint Server, also from Microsoft Corporation. To provide further example, if the computing device 302 is a smart phone or other mobile device, the operating system 302B-1 may be iOS, WP7, or any other available mobile operating system. The system memory 302B may also include one or more software applications 302B-2 and may include program data 302B-3. The one or more software applications 302B-2 may be in the form of mobile applications in examples wherein the computing device is a mobile device.

The computing device may have additional features or functionality. For example, the device may also include additional data storage devices 302C (removable and/or non-removable) such as, for example, magnetic disks, optical disks, or tape. Computer storage media 302C may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media. The computing device 306 may include data storage media such as the data storage media 302C described above, on which application data is stored.

In some examples, one or more of the computing devices 302, 306 can be a smart phone or other mobile device. In other examples, the computing device can be a personal computing device that is networked to allow the user to access the application disclosed herein at a remote location, such as in a player's home or other location. In some embodiments the disclosed application is stored as data instructions for a mobile application. A network 304 facilitates communication between the computing device 302 and one or more servers, such as computing device 306, that host the application disclosed herein. The network 304 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network 304 including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, computing device 306 is a Web server. In this example, computing device 302 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of computing devices 302 and 306, the instructions cause the processor to perform one or more of the operations or methods disclosed herein. Examples of operations include the operations of the job searching application, such as registering for a user profile, posting a job, or searching for a job within the application.

Further, the computing device 302 or 306 may include image capture devices, whether a dedicated video or image capture device, smart phone or other device that is capable of capturing images and video. Further, the system may include smart phones with native or web-based applications that can capture, store and transmit time-stamped video and images to a central server. The system and method can also include location-data captured by a GPS-enabled application or device. The computing device 302 or 306 may also have WiFi or 3G capabilities.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A system for location-based employment placement comprising:
a computer network for management and transmission of location-based employment data;
a data storage device for storing location-based employment data;
a server configured to receive user and employment data, including a user's real-world geographic location as well as data related to employment in a defined proximity to user's real-world geographic location; and
a plurality of mobile computing devices configured to transmit data including a user's real-world geographic location.

2. The system of claim 1, wherein the server is configured to receive a user's personal profile data.

3. The system of claim 1, wherein the server is configured to receive a user's employment history data.

4. The system of claim 1, wherein the server is configured to receive a user's job posting data.

5. A computer-implemented method for employment placement comprising:
registering a user and a sponsor via the server;
receiving job posting data including a geographic location via the server;
verifying the source of the job posting data;
associating a real-world geographic location with an identifier;
transmitting the identifier of the real-world geographic location utilizing a mobile computing device of a user;
receiving the identifier via a computer network;
verifying the identifier; and
associating the identifier with a value via the computer network.

6. The method of claim 5, further comprising sending a message to a sponsor of the user based on the user's real-world geographic location.

7. The method of claim 6, wherein the sponsor affects the ability of the user to accept employment based on the real-world geographic location of the user.

8. The method of claim 5, further comprising allowing a player to share employment data via a social media service.
